(19) United States
(12) Patent Application Publication
(10) Pub. No.: US 2006/0220327 A1
(43) Pub. Date: Oct. 5, 2006

(54) Groove-mounted seals with integral antiextrusion device

(76) Inventor: Larry Rayner Russell, Houston, TX (US)

Correspondence Address: ELIZABETH R. HALL, 1722 MARYLAND STREET, HOUSTON, TX, 77006, US

(21) Appl. No.: 11/446,330

(22) Filed: Jun. 3, 2006

Related U.S. Application Data
(63) Continuation-in-part of application No. 09/788,970, filed on Feb. 19, 2001, now Pat. No. 7,055,829.

(51) Int. Cl. F16L 17/06

(52) U.S. Cl. 277/611

(57) ABSTRACT

The present invention relates to an elastomeric seal having an antiextrusion device molded integrally into or onto the low pressure side of the seal. The antiextrusion device is made of a corrugated strip integrally embedded into the elastomeric seal. One embodiment of the invention has the strip positioned with the midplane of its corrugations normal to the mating seal surfaces and parallel to the midplane of the seal groove. Another embodiment of the invention has the midplane of the corrugations canted within the seal. The antiextrusion device is applicable to annular seal rings, linear seals, or seals of more complex configuration.

CROSS REFERENCE TO RELATED APPLICATIONS

The present application is a continuation-in-part application of pending patent application Ser. No. 09/788,970 filed Feb. 19, 2001, and entitled “Antiextrusion Device” invented by Larry R. Russell.

### BACKGROUND OF THE INVENTION

1. Field of the Invention

The present invention relates in general to a groove-mounted elastomeric seals having an antiextrusion device molded integrally into or onto the low pressure side of the seals. More particularly, the invention relates to the integration of a corrugated strip into an elastomeric seal.

2. Description of the Related Art

Elastomeric seals are in common use in a wide variety of applications as a means for closing off a flow passageway (gap) between two parts. The parts are usually metallic and will, unless measures are taken, allow fluids to pass through the gap where the two pieces are joined. To prevent the escape or loss of fluid at these gaps, flexible elastomeric seals are typically used to close the gap between the two parts. To achieve this function, the elastomeric seal is placed in a cavity or groove in a first part so that a portion of the seal extends outwardly from the groove and the exposed side of the seal is comated with the surface of a second part. The prevention of fluid passage through a gap between such parts generally relies upon the maintenance of an initial interference fit of the seal with attendant interface biasing forces between the sealing element and the two parts.

Previously this initial interference fit, which is termed ‘presqueeze’ and refers to the condition prior to the application of fluid pressure, has been obtained either: a) passively from displacement-induced forces due to the size and protrusion of the elastomeric seal when mounted in the groove, or b) actively by compressing the elastomeric seal after it is mounted in the groove. Sanders et al. U.S. Pat. No. 5,437,489 shows examples of passively presqueezed seals, while Reneau U.S. Pat. No. 4,728,125 discusses an example of an actively presqueezed seal.

As fluid pressure is applied to one side of the elastomeric seal, the seal will deform and shift in the direction of the fluid pressure forces. With time under high pressure loads and/or as the pressure increases, the seal will continue to displace toward the low pressure side of its mounting groove and become further distorted and “cold flow” or “creep” into the adjacent gap. This time-dependent behavior is further enhanced if the elastomeric seal shrinks in volume or is softened by heat or its interaction with retained fluids. This problem is intensified when the elastomeric material begins to shear off into the gap to be sealed. In some cases the entire seal is displaced into the gap. Shearing and tearing of the elastomeric material from the extrusion of the seal into the gap can cause the seal to fail. These problems are significantly amplified as the size of the gap to be sealed is increased.

The industry has implemented a number of improvements in seals to help solve the problems of creep and extrusion, which lead to seal failure. Such improvements have enhanced elastomeric seal performance, but none of the improvements have fully solved the problem of creep and extrusion, particularly for large gaps and for high pressure situations.

A frequent improvement used for large gap or high-pressure situations has been to provide an antiextrusion device on the low-pressure side of the seal. This approach can minimize static and creep deflections of the seal into the seal gap. The typical antiextrusion device is made of a stiffer, stronger material than the seal elastomer. The antiextrusion device is positioned on the low pressure side of the seal and is either integrally bonded to the external surface of the seal or retained in the seal groove as a separate item. Either way, the antiextrusion device is generally positioned on the downstream face of the seal to protrude across the gap and support the seal. Antiextrusion devices assist in reducing sensitivity of the elastomer seal to creep, thereby aiding in the maintenance of the initial interference fit.

The antiextrusion device ideally should provide low resistance to its displacement (i.e., low stiffness) across the seal gap to permit large deflections of the device in that direction without the device undergoing permanent deformation. Concurrently, the antiextrusion device must provide both high stiffness and high strength to resist bending and shear distortion of the seal element into the gap. Sealing the gap and resisting creep of the seal into the gap requires that the antiextrusion device be supported by the groove either by direct contact with the groove wall or by some embedment or entrapment of the antiextrusion device within the body of the groove-mounted seal. This support permits the antiextrusion device to be supported either directly or indirectly by the low-pressure end wall of the seal groove so that it in turn can provide resistive forces to pressure tending to force the seal adjacent the gap into the gap. These requirements are very difficult to satisfy for linear, annular or circumferential seals for large gaps, because provision of adequate stiffness and strength for resisting movement into the gap generally requires that the antiextrusion device (ring) be provided with a geometry which causes the ring to have undesirably high resistance to distortion across the gap. Currently used antiextrusion devices can only span a very limited gap size without permanent distortion of the devices.

Two types of non-integral, metallic antiextrusion devices are used for large gaps for both linear and annular groove-mounted seals. One type (from Plidco International, Inc., Cleveland, Ohio) uses non-integral, bendable metallic fingers placed in the mounting groove on the low pressure side of the seal. These fingers have a common base strip that serves as an anchor, while each finger functions independently. In certain antiextrusion rings of this type, the individual metallic fingers undergo excess bending and are not reliable for multiple sealings. In fact, they have been known to evert due to inadequate bending strength or excessive gap in severe cases.

The second type of non-integral, metallic antiextrusion rings are knitted metal annular antiextrusion rings (Metex, Edison, N.J.). These knitted metal rings are suitable for relatively large gaps and are used for oilfield downhole packers. However, these knitted antiextrusion rings have very little elastic rebound, so that resetting of the seal is not advisable or necessarily feasible due to inability to fully retract.

Fredd (U.S. Pat. No. 3,118,682) discloses a third type of metallic antiextrusion device that is applicable for use both in grooves and for situations where the seal is supported on only one side. The Fredd antiextrusion device is corrugated so that the waves of its corrugations are either perpendicular to or only slightly inclined from the perpendicular to the local direction of extrusion through the gap to be sealed. The antiextrusion device is either fully embedded within the low pressure side of the seal or directly mounted on the low pressure side of the seal. In application, the low pressure groove side or the supporting shoulder on the low pressure side is frustroconical, while the mating member side is parallel to the local direction of extrusion. Thus the throat space between the low pressure groove side or the supporting shoulder on the low pressure side and the mating side converges with approach to the gap to be sealed. The Fredd antiextrusion device functions by being wedged into the converging throat as the seal is moved towards the seal gap by pressure. When the Fredd seal is wedged against the opposed sides of the throat, the ends of its corrugations bear against both the frustroconical support surface and against the mating member side. The corrugations then function similarly to beams supported on both ends and having some restraint on rotation of the ends. The doubly supported beam action of the corrugations thus resists the extrusion forces from pressure on the seal.

Kirschning (U.S. Pat. No. 707,930) also discloses the use of one or more corrugated loop elements inserted into a flat flange gasket intermediate between its inner and outer edges for the purposes of strengthening the gasket. The waves of the corrugated elements are perpendicular to the faces of the parallel-sided gap to be sealed with his gasket. In a first embodiment, the corrugated material does not extend completely through the gasket, so it consequentially is not supported at its transverse ends. For this case, the only radial resistance to extrusion is due to the hoop strength and stiffness from the corrugated elements. However, corrugating the loop elements greatly reduces the ability of the loops to resist radial expansion, since the loop element must distort sufficiently to completely stretch out the corrugations before it can offer substantial resistance to further expansion. If the loop corrugations are fully stretched out, the resulting deformation of the gasket is so severe that it will leak. The second Kirschning embodiment has its loop elements fully penetrating through the thickness of the gasket so that the exterior transverse ends of the loop elements bear against the faces of the flange when it is pretensioned. In the pretensioned flange condition in the absence of pressure, the loop elements are able to provide radial support to the gasket through beam action between the frictional support of the transverse ends of the elements by the flanges. However, when the pressure retained by the flanged connection is increased, the separation of the flange faces due to bolt stretch under pressure is sufficient to completely disengage one or both transverse ends of the loop elements before the normal pressure capacity of the flange is attained. This additional bolt stretch under load is more than enough to overcome any elastic rebound of the axially compressed loops. Thus, the loops of the second Kirschning embodiment are not supported at their ends under rated operating pressures and accordingly function only weakly like the first embodiment when the pressure is increased.

The use of antiextrusion rings made of more flexible materials, such as a stiff elastomer or plastic material, for large circumferential seal gaps requires that the size of the antiextrusion ring and seal be significantly increased in order to provide sufficient embedment of the antiextrusion ring to resist creep, bending, and shearing of the rings. For active mechanically compressed seals, such as in Reneau U.S. Pat. No. 4,728,125 or the Oceaneering “Smart Flange Plus” (Oceaneering International, Inc., Houston, Texas), the larger rings and seals require larger seal compression hardware and a significantly larger and much more expensive housing. Again, provision of satisfactory resistance to bending distortion in the seal gap will impede the ability of the antiextrusion ring to adequately displace or span a large gap. Stiffer ring materials have improved creep and stiffness performance, but are less conformable to large gaps and generally will permanently distort when spanning larger gaps. Less stiff ring materials require even larger seal cavities to adequately embed them.

The significant areas of performance difficulty cited for large gaps and high pressures with conventional seals frequently lead to leaks or complete seal failures. For critical service conditions, such as deep water subsea pipeline repair clamps or hot-tap pipeline fittings, revisiting the clamp for adjusting the compressional preload on installed seals is prohibitively expensive. Further, providing more compressional preload through interference fits in such cases is not practical for passive seals for reasons of installation damage to the seal due to excessive interference and an increased tendency of the seal to creep and extrude through the gap with high preloads. Additionally, the use of much larger seal cross-sections in an effort to minimize seal extrusion problems significantly increases the size and cost of the hardware mounting the seal.

Thus, a need exists for antiextrusion devices for seals that can perform in large gap and high pressure situations.

### SUMMARY OF THE INVENTION

The invention contemplates a simple, inexpensive device for solving the problems and disadvantages of the prior approaches discussed above. The present invention provides a simple, reliable means for avoiding seal extrusion for large gaps and high pressures.

One aspect of the present invention is an antiextrusion device made of a rigid corrugated material substantially in a circular planar arrangement.

A second aspect of the present invention is an antiextrusion device made of a rigid corrugated material substantially in a right frustroconical pattern.

A third aspect of the present invention is an antiextrusion device made of a rigid corrugated material in a linear strip.

A fourth aspect of the present invention is an antiextrusion device made of a rigid corrugated material and positioned within a seal at a fixed distance from the low pressure lateral face of the seal.

A fifth aspect of the present invention is the provision of multiple rigid corrugated antiextrusion devices within a single seal.

A sixth aspect of the present invention is the provision of an antiextrusion device which is fully embedded in the body of the seal.

In accordance with another aspect of the invention, an elastomeric seal is described having one or more antiextrusion devices made of a rigid corrugated material embedded in and bonded to the elastomeric material in the seal.

In accordance with yet another aspect of the invention, a sealing unit is described that has an elastomeric seal containing an embedded antiextrusion device, a static seal end and a movable seal end. The movable seal end can be moved from its original position to stretch the elastomeric seal and displace the antiextrusion device. The movable seal tension can then be released to permit the seal and the embedded antiextrusion device to attempt to return to their original positions.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a frontal view of a first embodiment of an annular corrugated antiextrusion device, wherein the midsurface of the corrugations is planar.

FIG. 2 shows a side view of the embodiment of the corrugated antiextrusion device of FIG. 1.

FIG. 3 illustrates a quarter-sectional view of the first embodiment, shown in FIGS. 1 and 2, of an antiextrusion device embedded in an annular seal assembly unit, wherein the seal is stretchable. In this view, the seal is unstretched.

FIG. 4 illustrates a perspective view of the annular seal assembly shown in FIG. 3 partially cut away to show a corrugated antiextrusion device embedded in the seal.

FIG. 5 shows the annular seal assembly of FIGS. 3 and 4 wherein the seal is stretched prior to final assembly with its comating part.

FIG. 6 shows the annular seal assembly of FIGS. 3, 4, and 5 wherein the seal is sealing with its comating part.

FIG. 7 shows a quarter-sectional view of a seal for mounting in a prepared groove, wherein the antiextrusion device of FIGS. 1 and 2 is mounted near to the low pressure side of the seal.

FIG. 8 illustrates the seal of FIG. 7 sealing against a comating part.

FIG. 9 shows a seal corresponding to the seal of FIGS. 7 and 8, but wherein the seal is provided with multiple antiextrusion devices of the first embodiment.

FIG. 10 shows a perspective view of a second embodiment of a right frustoconical corrugated antiextrusion device.

FIG. 11 shows a side profile view of the second embodiment antiextrusion device of FIG. 10.

FIG. 12 shows a stretch seal similar to that shown in FIGS. 3-6, but with the antiextrusion device of FIGS. 10 and 11 embedded in the seal.

FIG. 13 shows a view of a linear embodiment of the antiextrusion device along the midplane of corrugations transverse to the wave pattern.

FIG. 14 shows a view of the antiextrusion device of FIG. 13 normal to the midplane of the corrugations.

FIG. 15 shows a linear embodiment of a seal with the antiextrusion device of FIGS. 13 and 14 embedded in the seal wherein the midplane of the corrugations of the antiextrusion device is normal to the comating sealing surface of the seal.

FIG. 16 shows a linear embodiment of a seal with the antiextrusion device of FIG. 13 and 14 embedded in the seal wherein the midplane of the corrugations of the antiextrusion device is at an angle Ø of 45° to 135° to the comating sealing surface of the seal.

FIG. 17 shows the seal of FIG. 15 installed in a linear seal groove, but not sealingly abutting a comating surface.

FIG. 18 illustrates the installed seal of FIG. 17 preloaded against its comating seal surface.

FIG. 19 illustrates a perspective view of the seal element shown in FIG. 16 where the seal has been partially cut away to show the placement of the antiextrusion device of FIGS. 13 and 14 embedded in the seal.

FIG. 20 shows another linear seal embodiment wherein the linear antiextrusion device of FIGS. 13 and 14 is bonded to the low pressure side of the seal. The seal is shown from its sealing face normal to the axis of the seal.

FIG. 21 shows an end view of the seal of FIG. 20.

FIG. 22 is an oblique view of the seal of FIGS. 20 and 21.

### DESCRIPTION OF THE PREFERRED EMBODIMENTS

The present invention provides elastomeric seals having an antiextrusion device molded integrally into the low pressure side of the seals. By strengthening the low pressure side of the elastomeric seal, it becomes resistant to both any initial displacement into the seal gap and any time-dependent continued deformation through the seal gap resulting from creep or “cold flow”. In particular, the present invention is applicable to large seal gaps, such as occur for pipeline repair clamps.

The present invention integrates an antiextrusion limiting means with seals to assist in the control of relative displacements into the seal gap and to provide reversible, repeatable displacements across the seal gap under varying pressures and gaps. Various antiextrusion ring designs were studied for their suitability to be integrally molded into an elastomeric seal. Most of the available antiextrusion ring designs are not suitable for integral molding into an elastomeric seal, and even if they were incorporated into seals they would not provide both the low resistance to displacement across the seal gap (necessary for stability in large gaps) and the necessary stiffness and high strength to resist extrusion and creep into the gap under high pressure.

The type of antiextrusion device selected for use in the present invention is corrugated in order to improve both its stiffness and strength in a first direction while simultaneously reducing its stiffness in a second direction. Webster's New Collegiate Dictionary, G. C. Merriam Co., Springfield, Mass., 1975, Page 256 defines “corrugate” as: ‘to form or shape into wrinkles or folds or into alternating ridges and grooves. From the Latin corrugatus, the past participle of corrugare, from corn-+ruga (wrinkle)”. The word “corrugated”, such as is applied to cardboard or corrugated metal sheeting, generally refers to the corrugation of a sheet material produced by inducing a repetitive wavelike pattern with alternating displacements to either side of the midsurface of the sheet. The midsurface is determined as the surface halfway between the peaks of adjacent corrugated wave ridges and grooves. The form of the waves may be rectangular, sinusoidal, triangular, or any repetitive pattern characterized by alternating displacements to either side of a midsurface. The shape of the wave displacement to a first side of the midsurface is not necessarily symmetrical with the wave displacement to the opposed, second side of the wave midsurface.

While the midsurface of a surface wave pattern is often planar, as in the case of ocean waves, it need not necessarily be. For example, if a sheet of planar corrugated metal is bent in a constant radius about an axis that is parallel to the ridges and offset from the unbent plane of the corrugated sheet, the midsurface of the corrugations is cylindrical, rather than planar. Likewise, a corrugated sheet can be formed so that it has a conical or frustroconical midsurface.

The presence of corrugations in a sheet of material significantly affects the bending properties of the sheet, while also impacting the in-plane stiffness of the sheet. For a planar sheet of corrugated material lying in the X-Y plane with the crests and troughs of the corrugations extending in the X direction, the bending strength and stiffness about the Y axis are considerably enhanced, while the bending strength and stiffness about the X axis are slightly reduced. The in-plane stiffness and strength in the X direction are slightly increased by the same corrugations, while the in-plane stiffness in the Y direction is very strongly decreased. These changes of stiffness and strength may be seen in a folding corrugated paper fan. For the case of circular symmetry of a corrugated ring, either planar or frustroconical, having its corrugations parallel to the generator of the ring midsurface, the stiffness in the hoop direction is considerably reduced, while the bending stiffness and strength about an axis tangent to the midsurface and perpendicular to the midsurface generator are appreciably increased.

Antiextrusion devices are commonly used in commercially available pressure-containing seals. For example, Crane Packing Company, Morton Grove, Ill. has bonded an elastomer to a metal reinforcing washer. The metal washer serves as an internal antiextrusion ring, but the radial inflexibility of the washer causes the ring to be unsatisfactory for large gaps.

Conventional metal piston rings and laminar sealing rings exhibit a high ratio of radial wall thickness to thickness in the axial direction to enhance the support provided by the seal cavity and the stiffness of the rings. However, the attendant high resistance to change of the ring diameter makes metal piston rings and laminar rings unable to readily conform to large gaps. Using split rings results in shear of the elastomer adjacent the split.

American Variseal in Broomfield, Colo. markets three types of U-cup seal expander springs. These U-cup seal expander springs provide low circumferential stiffness to permit conformance to large annular gaps. However, the slanted helical spring and the flat-wire helical coil spring would be difficult to mold into an elastomeric seal and offer both very low torsional stiffness and low bending and shear strength. Additionally, the bonding surface for the slanted helical spring is very limited. The third type has an alternating radially-oriented cantilever spring. This spring would be easy to mold into a seal with the cantilever beam axes in either a planar or conical configuration. Hirschmann Gmbh (Hirschmann Engineering, Chandler, Ariz.) also uses this same type of relatively weak alternating cantilever spring in a non-integral planar configuration retained by detent grooves in an elastomer as a low-pressure axial shaft seal. However, this type of ring has insufficient beam strength and stiffness to elastically resist distortion of the seal into a large gap under high pressure.

Corrugated metal-to-metal seals with the midplane of the coplanar circumferential corrugation waves parallel, rather than normal, to the faces to be sealed have been used for annular flange face seals (Parker Hannifin Corporation, Sulphur, La. and Metallo Gasket Company, New Brunswick, N.J.). The corrugations are multiple concentric annular ridges of different diameters. The crests of the corrugation waves bear on the surfaces of the flanges to provide multiple annular seal lines. Use of the corrugations provides multiple possible sealing lines and adds very low level flexibility to deal with flange gap irregularities and disturbances. However, this situation is not similar to the spanning of a large circumferential or linear gap.

Mildly corrugated wave springs for axially preloading a wedge expander to spread and engage the sealing lips of a circular U-cup type of seal with its comating sealing surfaces has also been used. For this case, the midplane of the corrugation waves is normal to the cylindrical sealing faces, but the wave spring is used only for force application and does not provide a backup function.

Hydrodyne, a division of F.P.I., Hollywood, Calif. produces corrugated metallic seals as flange face seals with a cylindrical midsurface normal to the flat comating sealing faces. These seals provide only a minor flexibility to the seals to compensate for irregularities and variations in the seal gap. Other Hydrodyne metallic seals are not actually corrugated, but use the central rib to stiffen the U-shaped cross-section of the ring against axial deflection. None of these seals are suitable as antiextrusion devices.

Corrugated Marcel wave spring expanders have been used to radially expand a relatively rigid split plastic piston ring. However, the midsurface of the corrugation waves is cylindrical and parallel to the cylindrical seal mating faces. Although these expanders provide a radial force on the ring, they are not suitable for antiextrusion service.

Microdot/Polyseal of Salt Lake City, Utah makes a seal having a corrugated four-piece construction that mounts in a standard groove for an O-ring with two O-ring backup rings. The relatively rigid seal ring itself is continuous with an essentially corrugated pattern and has a rectangular cross-section relatively small compared to the overall seal groove. The midsurface of the corrugations is planar and transverse to the comating cylindrical sealing surfaces. The abutment rings are also relatively rigid and are split, with one transverse face planar and the other face corrugated to closely mate with the seal ring. An elastomeric expander ring is used underneath both the seal ring and the abutment rings to preload the relatively rigid seal onto the sealed surface. This arrangement permits easy assembly of the substantially unstretchable seal into its groove, since its diameter is effectively increased whenever the corrugations are straightened under assembly tension (for male seals) or compression (for female seals). The seal is sufficiently rigid to not require antiextrusion rings, so the abutment rings function not as antiextrusion devices, but rather serve only to maintain the corrugated geometry of the installed seal ring necessary to take up the excess seal length provided to permit assembly. The abutment rings and the sealing element in this case are unsuitable for handling large gaps, since increasing the cross-sectional sizes of the elements to handle large gaps and high pressures makes this seal system very large and much harder to assemble.

The present invention uses a unique corrugated metallic seal molded into an elastomeric material that provides both the low resistance to distortion across the seal gap (necessary for seal stability in large gaps) and the necessary stiffness and high strength to resist creep and extrusion into the gap under high pressure.

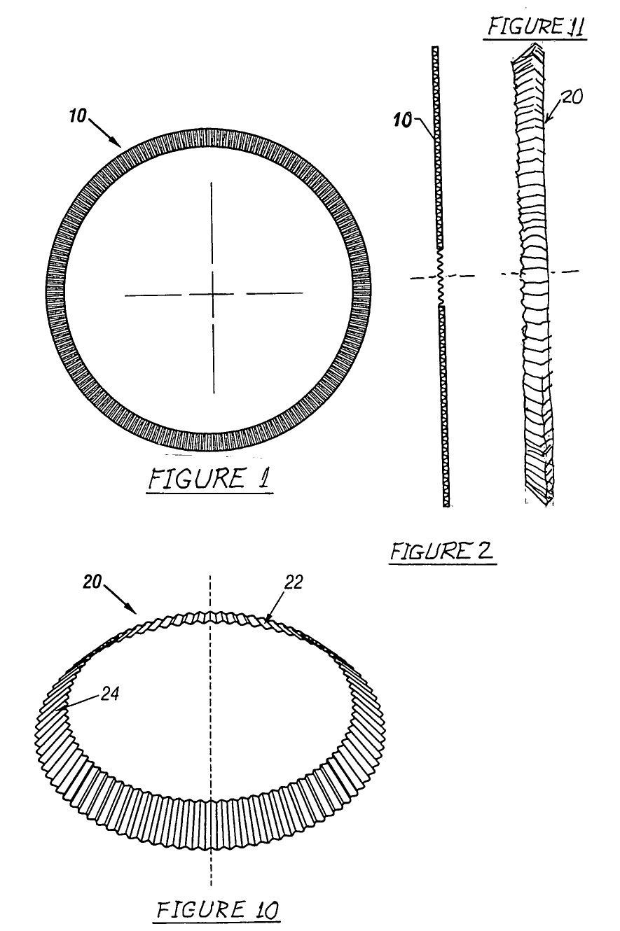

Referring now to the drawings, and initially to FIGS. 1 and 2, it is pointed out that like reference characters designate like or similar parts throughout the drawings. The figures, or drawings, are not intended to be to scale. For example, purely for the sake of greater clarity in the drawings, wall thickness and spacing are not dimensioned as they actually exist in the embodiment.

A first embodiment of the antiextrusion device 10 of the present invention suitable for application in either a female or male circumferential seal is shown in FIGS. 1 and 2. FIG. 1 shows a view in the axial direction of a substantially planar annular antiextrusion ring prior to molding, while FIG. 2 shows a corresponding radial side view. The waves of the corrugations of ring 10 extend radially.

In FIGS. 1 and 2, the antiextrusion device 10 of this embodiment is preferably constructed of a relatively thin metallic strip material such as carbon or stainless steel or a titanium alloy. For example, a corrugated metal strip that is formed in a generally circular pattern and is approximately 0.016 to 0.031 inch thick would be suitable for a 12-inch pipeline clamp at a maximum operating pressure of 3000 psi. The ratio of radial annular dimension of the corrugated material of the antiextrusion device 10 to the wave height of the corrugations (corrugated structure axial thickness) is on the order of 3 to 20, largely depending on the pressure capabilities required.

The midplane of the corrugations is normal to the axis of the ring 10. The corrugations may be formed by rolling, pressing, or other similar means so that they are uniform. Formed material can be welded into a loop if desired. It is desirable to form the corrugations in a pattern such that the ring will be approximately stress-free at the diameter at which it will be molded and used. The freedom from large locked-in stresses will ensure that the ring will remain substantially planar during molding, rather than becoming conical or otherwise distorting as a consequence of buckling.

The corrugations of the antiextrusion ring 10 stiffen and strengthen the ring against bending about axes which are in the midplane of the ring and perpendicular to radii for of the ring corrugations. Thus the ring 10 is stiffened against out-of-plane bending. Further, the corrugations significantly reduce the hoop stiffness of the ring 10, thereby permitting the ring to more easily conform to necessary radial movements when bonded into the elastomeric body of a seal which must be able to change diameter. Such radial movements are necessary in order to permit assembly of a seal with sufficient interference that preloading of the interface of the seal with its comating seal surface (“presqueeze”) can be provided. This necessary preloading would not be feasible if the antiextrusion ring 10 were not sufficiently flexible in the hoop direction, thereby permitting a seal containing the ring to easily change diameter adjacent the ring. And thereby avoid “nibbling” the seal.

FIGS. 10 and 11 illustrate another embodiment of an antiextrusion device 20. Antiextrusion device 20, like the antiextrusion device 10 of FIG. 1, is constructed of a corrugated rigid material, such as a thin metallic strip. The planar ring of FIG. 1 is a degenerate version of the conical ring (i.e., ring 10 has a 90° angle between the cone axis and the generating ray of the cone). The antiextrusion device 20 is formed in substantially a right frustoconical ring pattern having an outer conical side 22 and an inner conical side 24, where the angle between the axis of the cone and its sides is typically 45° to 90°. The generator for the frustroconical midsurface of the antiextrusion device 20 is inclined at an angle from its axis of rotation. Antiextrusion devices having right frustoconical ring patterns provide the desirable reduced seal circumferential stiffness and can offer comparatively reduced elastomer-to-ring bond stress through their provision of additional bonding surface area compared with a noncorrugated device. Although conical antiextrusion devices are somewhat more complex to manufacture and mold into a seal than planar ones, the use of conical ring patterns is not otherwise precluded.

The corrugations of antiextrusion rings 10 and 20 both provide significant increases in bending stiffness for a bending axis which is perpendicular to the corrugations and lying in the midsurface of the corrugations perpendicular to the generator of that midsurface when compared to the stiffness of a flat strip of the source material. Simultaneously the corrugations markedly decrease the circumferential stiffness of the ring, so that resistance to changes in the diameter of the overall antiextrusion device 10 or 20 are significantly smaller by more than one order of magnitude when compared to an uncorrugated ring with the same material thickness.

The examples of seals using antiextrusion devices shown herein are shown to be groove-mounted female seals. However, as may be recognized readily by those skilled in the art, the same general seal construction is readily applicable to male seals. For a male seal, the construction shown herein for the female seals would be everted.

For the purposes of examples herein, the seals are all assumed to be groove-mounted. For the annular seals, the housing grooves are assumed to have annular rectangular cross-sections with two transverse sides, and the seals are assumed to have rectangular cross-sections. The seals of the present invention can be used in grooves for which one or both sides are not transverse so that the throat is smaller than the main portion of the groove, but the sides should not be inclined more than a few degrees. In any case, use of non-transverse sides will require distorting and forcing the seal into its groove. Herein, the seals are shown with two types of mounting. For some of the embodiments, the transverse ends of the seal are bonded to pieces on either side during manufacture. In the case of bonded construction, the requirement of nearly rectangular cross-sections for seals using the antiextrusion devices of the present invention can be eliminated, since the seals are preassembled between their end pieces during manufacture and hence do not have to forcefully installed in grooves during assembly of the seals into a pressure-containing device.

FIG. 3 shows an annular elastomeric sealing unit 36 in which the annular seal 32 is bonded on its transverse ends to both a first and a second metallic end ring 33 and 35. The cross-section of the elastomeric seal 32 is generally rectangular, except that it has an inward bulge toward its inner side where it will sealingly mate with a comating cylindrical surface (as shown in FIG. 6). This inward bulge is present for the purpose of inducing presqueeze for the seal.

This sealing unit 36 is axially extensible to aid in its assembly with a comating sealing surface and is further described in U.S. Pat. No. 6,648,339 entitled “Seal Assembly, Its Use and Installation.” The axial extension of the seal is used to minimize interference between the seal 32 and its comating sealing surface during assembly. Radial distortions of the elastomer seal 32 of the seal element 36 are not strongly resisted by the antiextrusion ring 10, so the seal unit 36 is readily conformable to varying diameters, imperfections, and ovalities of a comating pipe or mandrel. Yet because the antiextrusion ring 10 is essentially anchored into the matrix of the elastomer over most of its radial length and particularly at its outer diameter, the antiextrusion ring 10 strongly resists bending out of its plane. The stiffening and strengthening of the ring 10 by its corrugations greatly enhances the ability of the ring to resist extrusion of the relatively unsupported portion of the elastomeric seal 32 spanning the seal gap. The corrugation waves essentially function as cantilever beams which are substantially anchored in the relatively immobile elastomer deep in the groove (i.e., away from the comating sealing surface and the gap where elastomer extrusion occur).

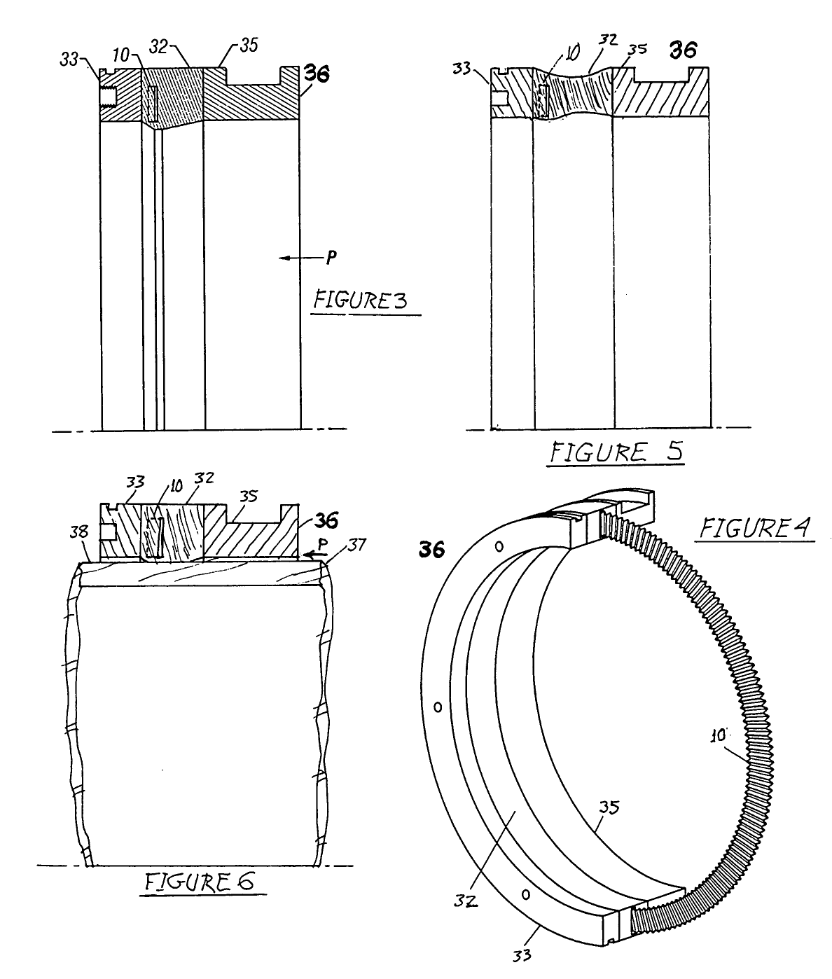

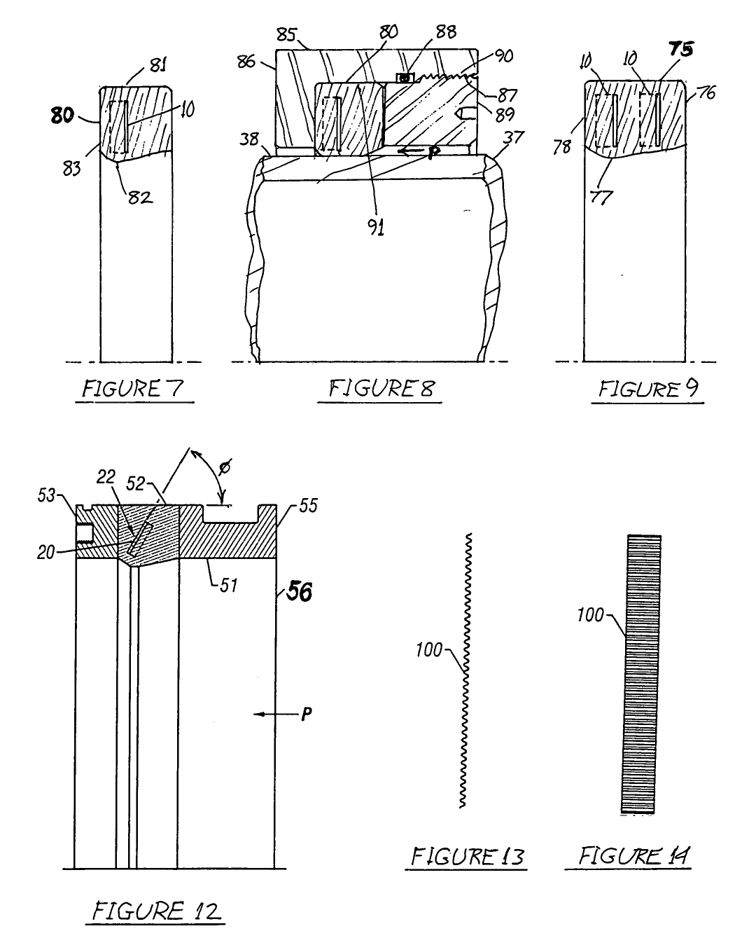

FIG. 4 is a perspective view of the sealing unit 36 where the elastomeric seal 32 and end rings 33 and 35 have been partially cut away to show the placement of the antiextrusion device 10 within the seal. The planar antiextrusion device 10 is totally embedded in and bonded to the elastomeric seal 32 so that it is covered by elastomer on its ends as well as on its sides.

The inner diameter of the antiextrusion device or antiextrusion ring 10 is recessed slightly from the inner and outer diameters of the elastomeric seal 36 so that it is covered on all sides and bonded to the elastomeric matrix. This provision of coverage of the antiextrusion device 10 by elastomer protects both the material of the antiextrusion element and the elastomer-to-antiextrusion element bond from attack by the fluids to be sealed, while also protecting any comating seal surface from contact damage from the antiextrusion element.

FIG. 5 shows the sealing unit 36 of FIGS. 3 and 4 in its stretched condition used for assembly to seal on a pipe 37. FIG. 6 shows the sealing unit 36 of FIGS. 3, 4, and 5 sealing engaged with the outer cylindrical surface 38 of a pipe 37. In FIG. 5, an annular female sealing unit 36 is molded with one or more of the antiextrusion rings 10 molded integrally within the elastomeric seal 32 on the low pressure side of the seal.

As seen in FIG. 6, the elastomeric seal 32 of sealing unit 36 will be distorted somewhat from its unstressed, molded condition when released from its tensioned installation condition to assume its presqueezed but unpressurized position against the surface 38 of a pipe 37. Further distortion from pressure biasing and retained pressure will occur as pressure against the seal increases above its zero initial value during installation. In FIG. 6, pressure P is assumed to be higher on the right side of the sealing unit 36 and the sealing unit is oriented so that the antiextrusion ring 10 is on the lefthand, low pressure side of the seal 32 so that it can aid in preventing seal extrusion into the gap between first end ring 33 and the pipe 37.

FIG. 7 shows another seal embodiment which is an unmounted annular female seal 80 having an integral antiextrusion ring 10 completely enclosed in the elastomer body 81 of the seal. Seal 80 is not bonded to any other part, but is suitable for loose mounting in a rectangular cross-section annular groove. The cross-section of the seal 80 is generally rectangular, but with an unsymmetrical inward bulge 82 on its interior face on the low pressure side of the seal so that an interference fit more readily can be obtained with its comating sealing surface. An antiextrusion ring 10 is placed near the transverse low pressure side 83 of the seal. As shown in FIG. 8, seal 80 is mounted in a grooved annular body assembly 85 which has a rectangular cross-section groove 91. Body assembly 85 consists of a right circular cylindrical tubular body 86 that has an inwardly projecting transverse shoulder that serves as one transverse side of the seal groove, while the bore of body 86 serves as the outer cylindrical portion of the groove 91. The bore of body 86 is a close fit to the outer cylindrical surface of the seal 80. The outwardly opening end of body 86 is provided with an O-ring groove housing an O-ring 88 and female threads 87. A right circular cylindrical keeper ring 89 having transverse ends, a bore equal to that through the transverse shoulder of body 86, an outer cylindrical surface against which O-ring 88 is comated and sealed, spanner holes, and male threads 90 threadedably engagable with the female threads 87 of the body 86 provides the other side of the groove 91 for the seal 80.

In FIG. 8, the seal 80 is installed in its groove 91 and has an interference fit with the outer cylindrical surface 38 of pipe 37. Assembly of the mounted seal 80 with its comating sealing surface 38 of pipe 37 requires that the rubber of the seal displace radially outwardly without the cutting of the rubber by the antiextrusion ring 10. The antiextrusion ring 10, positioned on the low pressure side of the seal 80, serves to eliminate extrusion of the elastomeric body 81 of seal 80 through the gap between the shoulder of body 86 and the comating surface 38 for the seal 80. Again, the elastomeric body 81 of the seal 80 substantially anchors the interior end of the corrugations so that they can function as cantilever beams in order to resist tendencies of the elastomer to distort.

The separable body 85 for the seal 80 shown in FIG. 8 would be used for instances where the seal would be damaged by permanent distortion of the antiextrusion ring 10 during installation. This type of problem can arise for a seal having a small diameter relative to its cross-sectional radial thickness. This separable type of body 85 is not necessary when the mean diameter of the antiextrusion ring 10 and its seal 80 are relatively large relative to the depth of the groove 91. For the larger diameter-to-groove depth situation, a one-piece groove construction is feasible.

FIG. 9 shows another embodiment 75 of an unmounted annular seal for use unbonded into its mounting groove. The structure of seal 75 is substantially similar to that of seal 80, but multiple antiextrusion rings 10 completely enclosed in the elastomer body 76 of the seal are used in this embodiment. Seal 75 can be mounted in a prepared rectangular cross-section groove without being bonded into the groove. The cross-section of the seal 75 is rectangular, but with an unsymmetrical inward bulge 77 on its interior face so that an interference fit more readily can be obtained with its comating sealing surface. A first antiextrusion ring 10 is placed near the transverse low pressure side 78 of the seal 75, with a second antiextrusion ring 10 placed in an intermediate position between the transverse ends of the seal. Typically, the axial spacing between the two rings 10 would be approximately twice the wave height for the corrugations. More than two antiextrusion rings 10 can be used if desired. As the elastomer of the body 76 distorts, the multiple rings 10 coact to help prevent extrusion through a seal gap. The use of a symmetrical elastomer body 76 with an antiextrusion ring adjacent both transverse ends permits the creation of a bidirectional seal having equal antiextrusion resistance in both directions. The limitations on the type of groove in which seal 75 can be used are the same as those for seal 80. The antiextrusion behavior of the seal 75 and its integral antiextrusion rings 10 is substantially similar to that of the seal 80.

FIG. 12 shows an embodiment of an annular elastomeric sealing unit 56 similar to that shown in FIGS. 3 to 6, but using the frustroconical antiextrusion ring 20 instead of the planar ring 10. For sealing unit 56, the circumferential seal 52 is bonded to first and second metallic end rings 53 and 55. The corrugated conical antiextrusion device 20 is integrally molded into and bonded to an elastomeric seal 52 with its conical axis substantially concentric with the axis of the annular seal 52. The corrugated wave crests run parallel to the conical generating rays, with the wave pattern of the corrugations being uniform and regular. Typical wave profile patterns would be either substantially sinusoidal, rectangular, or trapezoidal.

The annular antiextrusion device 20 of FIG. 12 is embedded such that the midsurface of the corrugations of the device 20 is at an angle of Ø=45° to 135° to the bore surface 51 and axis of the second end ring 55. In other words, the frustroconical ring 20 can be faced in either direction. One or more antiextrusion devices 20 can be molded into the elastomeric matrix of the seal 52 on the low pressure side of the seal as shown in FIG. 12. As shown in FIG. 12, the outer conical side 22 of the device 20 is directed toward the low pressure side of the seal 52. However, it may be advantageous to reverse this orientation of the frustroconical antiextrusion ring in some cases. The behavior of the sealing unit 56 with its integral antiextrusion ring 20 is very similar to that of sealing unit 36. Typically, the sealing unit 56 will be easier to deform radially during assembly than would be the case for the sealing unit 36.

FIGS. 13 and 14 show a third embodiment 100 of the antiextrusion device of this invention suitable for use with linear seals, such as those shown as longitudinal seals in the split pipeline repair clamp of Sanders, et al. U.S. Pat. No. 5,437,489. FIG. 13 shows a view along the midplane of a corrugated antiextrusion strip 100, while FIG. 14 shows a view of the same strip 100 normal to the midplane of the corrugation waves. The corrugations of rigid antiextrusion strip 100 are regular in profile and are formed by rolling or pressing or other suitable means. Herein, the corrugations are shown to be approximately sinusoidal in shape, but trapezoidal, rectangular, or triangular profiles can also be suitable.

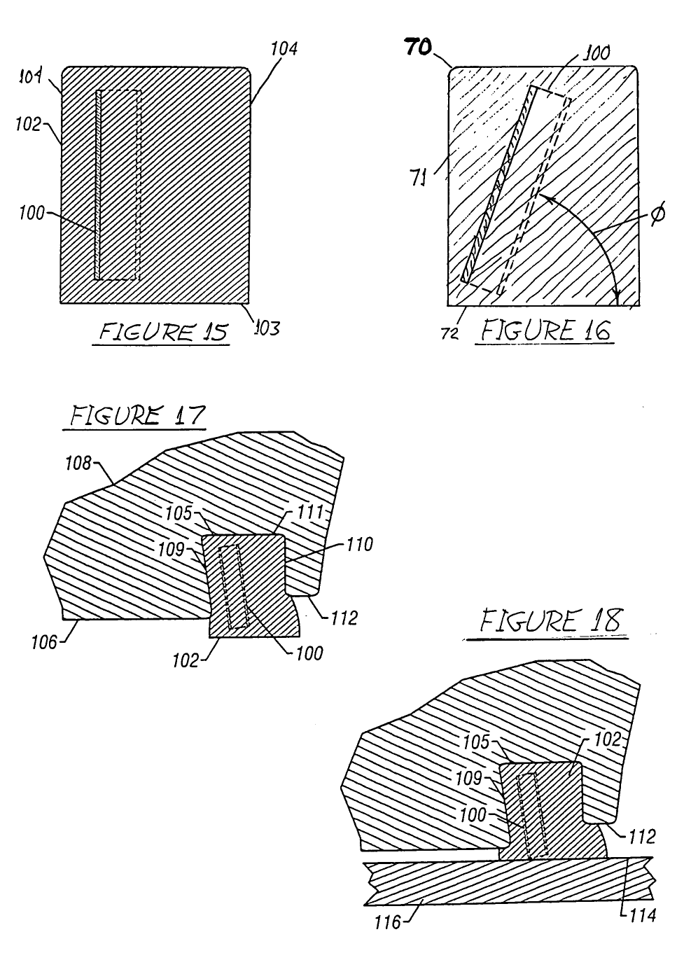

FIGS. 15 and 16 show the antiextrusion strip 100 of FIGS. 13 and 14 molded into the matrices of passive linear elastomeric seals 102 and 70, respectively. The second linear seal embodiment 70 has its antiextrusion strip 100 inclined from the sealing face 72 by an angle Ø. The term ‘passive’ indicates that for the seals 102 and 70, no means is provided for adjusting their presqueezes other than bringing the seals closer to or farther from the comating surface against which they will seal.

The alignment of the corrugations of the antiextrusion strip 100 with the seals 102 and 70 enables the reinforced seals 102 and 70 to be bent readily about axes parallel to their corrugations in order to accommodate seal insertion into and use for sealing with nonlinear grooves. This flexibility is particularly useful for passive transverse seals on split pipeline repair clamps. At the same time, the alignment of the midsurface of the corrugations transverse or nearly transverse to the extrusion gap for the installed seals greatly strengthens and stiffens the seals.

The first linear seal embodiment 102 has its antiextrusion strip 100 perpendicular to the sealing face 103 of the seal. The cross-section of linear elastomeric seal 102 is basically rectangular, having a comating sealing face 103, two opposed transverse sides 104, and having the two corners which will be inserted into a seal groove typically slightly radiused. The other two corners between the sealing face 103 and the sides 104 may also be radiused. The length of the elastomeric seal 102 is slightly more than that of antiextrusion strip 100 to ensure full embedment of the strip.

Antiextrusion strip 100 is covered on all sides by elastomer for corrosion protection and to minimize any possible deterioration of the bond between the elastomer and the strip. Antiextrusion strip 100 is positioned closer to the low-pressure side of elastomeric seal 102 than it is to the high-pressure side. Proportions may vary somewhat, depending on the stiffness of the elastomer, maximum pressure, expected seal gap range, and the like. Typically the ratio of the height normal to the comating surface to the width parallel to the comating surface of the seal 102 will range from about 0.2 to about 2.0. The width of the antiextrusion device will range from about 0.75 to about 0.90 times the height of the seal 102. Approximate proportions for a typical seal vary. For example, the width of a seal may be approximately 1 inch and the height of the seal about 1.25 inches with an embedded corrugated strip being about 1 inch high and about 0.024 inch thick with corrugations 0.25 inch from peak-to-peak with a wavelength of 0.5 inch. The strip would be covered with a minimum of approximately 0.063 inch to 0.188 inch of elastomer.

In FIG. 16, the antiextrusion strip 100 is embedded such that the strip 100 is canted to reduce the bond stress under presqueeze and pressure between the elastomeric matrix of the seal 102 and the antiextrusion strip 100. The cross-section of linear elastomeric seal 70 is basically a rectangular elastomeric strip 71 with a comating sealing face 72, two opposed transverse sides, and having the two corners which will be inserted into a seal groove typically radiused. The other two corners between the sealing face 72 and the sides may also be slightly radiused. The length of the elastomeric seal 70 is slightly more than that of antiextrusion strip 100 to ensure full embedment. The antiextrusion strip 100 is embedded in the elastomeric matrix 71 so that the midplane of the corrugations of strip 100 is at an angle 0 to the comating surface 106 of seal 102. Angle Ø preferably ranges between 45 degrees and 135 degrees.

FIG. 17 shows the linear elastomeric seal 102 of FIG. 15 positioned into a seal groove 105 such as would be used in the longitudinal seal groove of a split pipeline repair clamp. The groove 105 is provided in face 106 of the carrier body 108, with its throat narrower than the seal width to provide a close fit between seal 102 and the inner portion of the groove 105 so that seal retention by friction and elastic forces is ensured. The seal groove 105 linearly expands in width from its throat into the body 108. The depth of groove 105 is less than the height of the cross-section of seal 102 so that sufficient seal protrusion will exist in order to ensure adequate presqueeze, even with large seal gaps. The low pressure side 109 of groove 105 is inclined towards the high pressure side 110 at its outer end, while the inner groove side 111 is parallel to the face 106 and the surface against which the seal will be presqueezed. The high pressure side 110 of groove 105 is normal to the face 106 and shorter than the low pressure side depth of groove 105. Groove relief face 112 is parallel to face 106. Groove relief face 112 is also closer to inner groove side 111 than is face 106. Relief volume for absorbing the elastomer displaced volume when the seal gap is reduced or varied is provided by the increased separation relative to face 106 of groove relief face 112 from the surface against which elastomeric seal 102 will be presqueezed. All groove corners are radiused in order to avoid elastomer tearing or shearing. The distortion of the rubber of the seal 102 by the fitting of the seal into its mounting groove 105, seen in both FIGS. 17 and 18, causes the antiextrusion strip 100 to be inclined from perpendicular to the comating sealing surface 114.

Optionally, seal 102 may have elements having high frictional coefficients integrally bonded into the elastomeric matrix of the seal on the comating surface. For example, silica flour may be incorporated onto the comating surface of seal 102. An increase in friction between the comating surfaces will tend to increase the resistance of the seal to creep.

FIG. 18 shows the elastomeric seal 102 in groove 105 of FIG. 15 sealing against the adjacent comating surface 114 of body 116. Sufficient presqueeze on elastomeric seal 102 has been provided by bringing comating surface 114 close enough to obtain a suitably high interface pressure between seal 102 and comating surface 114. The elastomer of seal 102 has distorted into the high pressure side relief volume provided between relief face 112 and comating surface 114 due to the presqueeze compression. The presence of antiextrusion strip 100 adjacent low pressure side 109 of groove 105 and firmly embedded in the elastomer of seal 102 which is in turn entrapped in groove 105 ensures that the antiextrusion strip is well anchored to resist transverse forces which would tend to displace its end adjacent comating surface 114. The main portion of the body of the corrugations of antiextrusion strip 100 is firmly anchored in the elastomer of the seal 102, which is in turn rigidly held in the interior of the groove. Accordingly, the corrugations again function as strong, stiff cantilever beams extending to the extrusion gap and thereby helping to prevent extrusion of the seal elastomer.

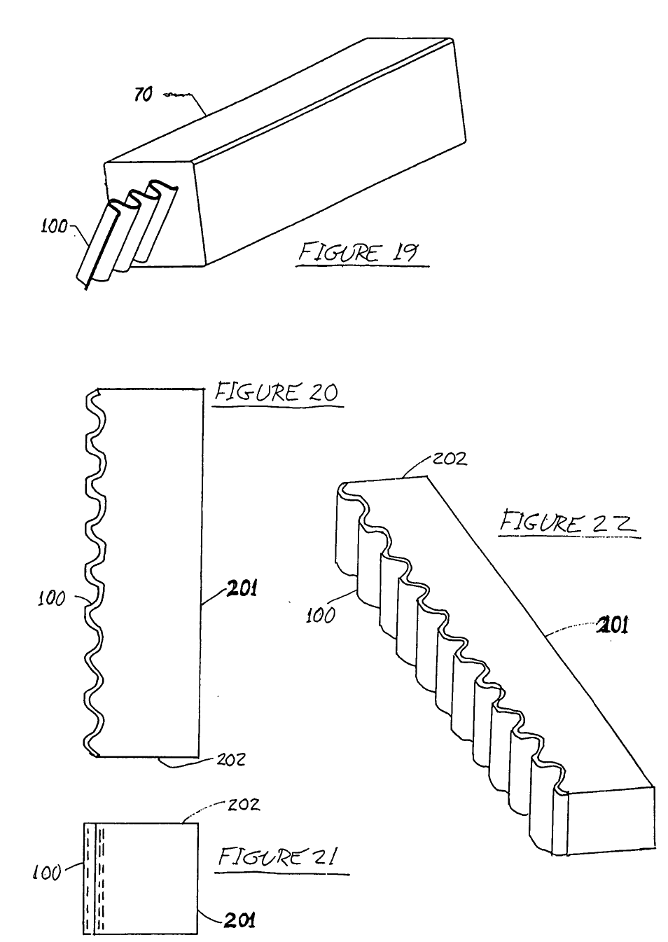

Although it is not shown herein installed in a groove or mating with a comating sealing surface, the seal 70, shown in FIG. 16, with its inclined antiextrusion strip 100 functions substantially in the same manner as the seal 102. The oblique view in FIG. 19 shows the seal 70 with a portion of its length cut away so that the positioning of the antiextrusion strip 100 can be more clearly seen. Use of the inclined strip 100 can ease installation of the seal into a groove similar to that shown in FIGS. 17 and 18, and the strip 100 is less likely to buckle or to cause the rubber of the seal 70 to be cut for large presqueezes of the sealed connection.

FIGS. 20, 21, and 22 show a final embodiment of a linear seal 200, wherein the reinforcing strip 100 is exposed on the low pressure side of the bonded seal body 201. For this arrangement, the height of the strip 100 should be less than that of the elastomer 201. Rather than being embedded within the elastomer of the seal body and directly supported thereby, the integral strip 100 of the seal 200 is positioned so that it directly bears on the transverse low pressure side wall of a rectangular groove. The trapping of the strip against the side of its rectangular cross-section mounting groove (not shown) by the elastomer of the seal body 201 provides the anchorage so that the strip can provide antiextrusion resistance through cantilevered beam tip forces at the extrusion gap. This particular construction has lower friction during insertion into a groove and less likelihood of cutting or tearing the rubber than would be the case for the linear seal embodiments 102 and 70.

The major advantage of this invention for linear seals accrues primarily from enhancement, by means of providing corrugated construction, of structural strength and stiffness of the antiextrusion strip for resisting pressure loads normal to the midplane of the corrugations. The same advantage applies generally to face seals and other seals of more complex pattern. A linear seal is essentially a segment of a circular face seal of infinite radius. The use of the linear antiextrusion strip is particularly advantageous for large gap situations and high pressures, both of which occur in pipeline repair clamps.

The basic advantages of this invention for annular seals accrue primarily from: a) enhancement, by means of providing corrugated construction, of structural strength and stiffness of the antiextrusion ring for resisting pressure loads normal to or with vector components normal to the midplane of the corrugations, and b) simultaneous reduction of circumferential ring stiffness through provision of the same corrugations so that large diametric changes can be accommodated without either high resistance or overstress and permanent distortion of the ring. The corrugated integrally molded antiextrusion ring can be used with any large gap seal, including the conventional active and passive types.

In all cases, the embedded corrugated antiextrusion device dramatically increases the extrusion resistance of the seal for large gaps without markedly decreasing the desirable conformability of the seal to the comating seal surface. Accordingly, these seals provide low resistance to distortion normal to the comating seal surface in response to both tensioning and pressure biasing. However, the integral corrugated antiextrusion ring can render an otherwise marginal conventional passive or active seal satisfactory for higher pressures. The improved stiffness properties of the annular seal antiextrusion ring for resisting bending and thereby minimizing elastomer extrusion into the seal gap markedly improve the performance of seals for large gaps and high pressures. At the same time, the corrugations appreciably enhance the radial flexibility of the antiextrusion ring by changing its mode of resistance from direct stress (tension or compression) to the much less stiff combined bending and twisting mode of the corrugated disk. Although the flexibility of the integrally molded corrugated antiextrusion insert for motion normal to the comating seal surface is unimportant for linear or near linear seal configurations, the corrugations still provide an enhanced bending stiffness for resisting extrusion for linear or near linear seals.

It is readily understood that the corrugation patterns of this invention, the seal types, and the positioning and number of the antiextrusion members in a seal may be varied to meet different demands. For example, the antiextrusion elements can be adapted readily to both semicircular and circular annular seals, linear or near linear or irregularly shaped seals, stretched or unstretched seals, and both male and female annular seals. The material for the antiextrusion member may likewise be nonmetallic or of composite construction and the positioning of the antiextrusion device(s) may be varied as necessary and practical. The corrugated antiextrusion means described herein offer practical, easily applied, and economical solutions for large gap seals, particularly for high pressure situations.

Having described several embodiments of seals with embedded antiextrusion devices, it is believed that other modifications, variations, and changes will be suggested to those skilled in the art in view of the description set forth above. It is therefore to be understood that all such variations, modifications, and changes are believed to fall within the scope of the invention as defined in the appended claims.

What is claimed is:

1. An antiextrusion device fully embedded and integral with an elastomeric seal mounted in an annular groove, the antiextrusion device comprising a rigid corrugated material substantially in a circular annular planar configuration and having multiple corrugations centered about a midplane of the antiextrusion device, whereby the corrugations enhance the bending strength of the antiextrusion device for loads normal to the plane of the device while reducing the circumferential stiffness of the antiextrusion device.

2. The antiextrusion device of claim 1, wherein the ratio of a radial annular thickness of the corrugated material to a wave height of the corrugations ranges from about 3 to about 20.

3. The antiextrusion device of claim 1, wherein a radial wave pattern of the corrugations is a repeatable uniform pattern.

4. The antiextrusion device of claim 3, wherein the wave pattern is substantially sinusoidal, rectangular, triangular or trapezoidal.

5. An antiextrusion device fully embedded and integral with an elastomeric seal mounted in an annular groove, the antiextrusion device comprising a rigid corrugated material substantially in a right frustoconical configuration and having multiple corrugations displaced about a frustoconical surface, whereby the corrugations enhance the transverse bending strength of the antiextrusion device while reducing the circumferential stiffness of the antiextrusion device.

6. The antiextrusion device of claim 5, wherein an angle between an axis of the cone and a side of the cone ranges from about 45° to 90°.

7. The antiextrusion device of claim 5, wherein the antiextrusion device has a height in a radial direction less than a maximum radial height of the elastomeric seal.

8. The antiextrusion device of claim 5, wherein the ratio of radial annular thickness of the corrugated material to the wave height of the corrugations ranges from about 3 to about 20.

9. The antiextrusion device of claim 5 having a multitude of corrugations with a wave pattern of the corrugations in a repeatable uniform pattern, wherein each corrugation has a crest and a trough lying in a radial plane.

10. The antiextrusion device of claim 9, wherein the wave pattern is substantially sinusoidal, rectangular, triangular or trapezoidal.

11. An annular elastomeric seal comprising:
an annular elastomeric body having a first surface for sealingly engaging a comating sealing surface to contain a pressure, two opposed end surfaces, wherein the elastomeric body is mountable in an annular groove having opposed sides for engaging the opposed end surfaces of the elastomeric body; and
an antiextrusion device comprised of a rigid corrugated material having a repeatable uniform pattern of multiple corrugated alternating wave crests and troughs, said antiextrusion device fully embedded in and bonded to the elastomeric body such that individual wave crests lie in radial planes;
whereby the corrugated wave crests and troughs cooperate with the elastomeric body to enhance a resistance of the seal to displacement parallel to the comating sealing surface in response to the contained pressure while reducing a circumferential stiffness of the seal.

12. The elastomeric seal of claim 11, wherein the antiextrusion device has substantially a planar annular configuration.

13. The elastomeric seal of claim 12, wherein a midplane of the corrugated material is normal to an axis of the annular seal.

14. The elastomeric seal of claim 11, wherein the antiextrusion device has substantially a right frustroconical configuration.

15. The elastomeric seal of claim 14, wherein a midplane of the corrugated material is embedded at an angle ranging from about 45° to about 135° to an axis of symmetry of the elastomeric seal.

16. The elastomeric seal of claim 14, wherein an angle between an axis of the cone and a side of the cone ranges from about 45° to 90°.

17. The elastomeric seal of claim 11, wherein a ratio of a radial annular thickness of the antiextrusion device to a height of a corrugation of the antiextrusion device ranges from about 3 to about 20.

18. The elastomeric seal of claim 11, wherein a plurality of antiextrusion devices are embedded in a parallel position to each other in the elastomeric body.

19. The elastomeric seal of claim 18, wherein the antiextrusion devices are axially separated in the seal by a distance equal to or greater than twice a height of a corrugation.

20. The elastomeric seal of claim 11, wherein the antiextrusion device is embedded closer to a one side of the seal than to a second side of the seal, said one side designed to be a low pressure side of the seal.

21. The elastomeric seal of claim 11, wherein the antiextrusion device is embedded a predetermined distance from a low pressure side of the seal.

22. The elastomeric seal of claim 11, wherein the first surface of the seal has a material having a high friction coefficient embedded therein.

23. The elastomeric seal of claim 11, wherein the elastomeric material has a constant cross-sectional shape and a plurality of antiextrusion devices embedded in and bonded to the elastomeric material in a parallel position to each other axially separated by a distance equal to or greater than twice a wave height of a corrugation.

24. A linear elastomeric seal comprising:
a linear elastomeric body having a first surface for sealingly engaging a comating sealing surface to contain a pressure, two opposed lateral surfaces, wherein the elastomeric body is mountable in a groove having opposed sides for engaging the opposed lateral surfaces of the elastomeric body; and
an antiextrusion device comprised of a rigid corrugated material having a repeatable uniform pattern of multiple corrugated alternating wave crests and troughs, said antiextrusion device fully embedded in and bonded to the elastomeric body such that individual wave crests are perpendicular to a linear axis of the seal;
whereby the corrugated wave crests and troughs cooperate with the elastomeric body to enhance a resistance of the seal to displacement parallel to the first surface of the seal and normal to the linear axis of the seal in response to the contained pressure while reducing an axial stiffness and a lateral bending stiffness of the seal.

25. A method of sealing a flow gap between two parts comprising:
mounting the elastomeric seal of claim 24 into a seal groove, the groove located on a surface of a first part, said surface being one side of the flow gap, wherein a height of the seal is greater than a depth of the seal groove and a comatable sealing surface of the seal protrudes from the groove; and
distorting the seal by compressing a comating surface of a second part against the comatable surface of the seal, said outside surface compressively comating with a comating surface of the second part.

26. The method of claim 25, wherein the seal groove has a first side substantially normal to the surface of the first part and a second side normal to said surface of the first part or inclined to normal by 0° to 30°.

27. The method of claim 26, wherein the first side is shorter than the second side and the first side faces a high pressure side of the flow gap and the second side on a low pressure side of the flow gap.

28. The method of claim 25, wherein the seal groove has a first side normal to the surface of the first part or inclined to normal by 0 to 30° and a second side substantially normal to said surface of the first part.

29. The method of claim 28, wherein the first side is shorter than the second side and the first side faces a high pressure side of the flow gap and the second side on a low pressure side of the flow gap.
